(19) United States
(12) Patent Application Publication
(10) Pub. No.: US 2011/0106322 A1
(43) Pub. Date: May 5, 2011

(54) NETWORK CONNECTION MANNER OF MICROGRID ENERGY STORAGE BACKUP POWER SOURCE, AND METHOD FOR DISPATCHING THE SAME

(75) Inventor: Ting-Chia Ou, Taoyuan County (TW)

(73) Assignee: Institute of Nuclear Energy Research Atomic Energy Council, Executive Yuan, Taoyuan County (TW)

(21) Appl. No.: 12/877,768

(22) Filed: Sep. 8, 2010

(30) Foreign Application Priority Data
Oct. 30, 2009 (TW) 098136867

(51) Int. Cl. G06F 1/26

(52) U.S. Cl. 700/286

(57) ABSTRACT

A network connection manner of a microgrid energy storage backup power source and a method for dispatching the same are provided. A plurality of renewable energy storage systems of microgrid are jointed, so as to form a backup power source network for dispatching energies of different microgrids, and an improved genetic algorithm is used as a method for dispatching energies of the renewable energy storage systems, for improving the electric power dispatching function of the microgrid, so as to improve the electric power dispatching efficiency of different microgrids, thus achieving high quality power supply and optimal economic operation of an electric power system.

### CROSS-REFERENCE TO RELATED APPLICATION

This non-provisional application claims priority under 35 U.S.C. §119(a) on Patent Application No(s). 098136867 filed in Taiwan, R.O.C. on Oct. 30, 2010, the entire contents of which are hereby incorporated by reference.

### BACKGROUND OF THE INVENTION

1. Field of Invention

The present invention relates to a network connection manner of a microgrid energy storage backup power source, and a method for dispatching the same, in which a plurality of renewable energy storage systems of microgrids are jointed, and an improved genetic algorithm is used as a method for dispatching energies of the plurality of renewable energy storage systems, for enhancing electric power dispatching efficiency of different microgrids, so as to achieve high quality power supply and optimal economic operation of an electric power system.

2. Related Art

Along with the development of the operation of the electrical industry, the electric power quality in the electric power system is gradually developed towards an intellectualization and power-saving direction. The global energy source is limited, and the discharge capacity of carbon dioxide is strictly limited in the countries all over the world, such that it becomes a trend of the recent electric power system to develop new alternative energy sources, for example, solar energy, wind force, fuel cell, tide, geothermal heat, wave, and other renewable energy sources which may be repeatedly utilized and will not be exhausted. Generally, renewable energy source power plants, including the solar power, the fuel cell, and the wind electrical power generation, are all provided with energy storage systems, so as to provide a stable power supply. In addition to reducing the electric quantity supplied by a remote power source through a transmission line, the energy storage system also reduces the loss of electricity transmission and improves power supply efficiency. The electric power quality of the renewable energy source electric power system is relevant to a continuous supply load time of the system and a performance thereof, which mainly depend on whether the energy stored in a renewable energy resource system (RERS) may be effectively controlled and applied or not to supply the continuous operation of the load and the uninterrupted source of the energy storage, so as to achieve the stable power supply. The renewable energy storage system is usually constructed by combining battery units, and thus is mainly advantageous in gentle charging/discharging voltage, easy acquisition, and high security. Usually, the energy storage device of the RERS analyzes voltage signals returned from the batteries, and appropriately performs the charging and the protection according to different situations, so as to supply a stable direct current (DC) power source, and supply the power to the sensitive load through a stabilizing device, thereby preventing from affecting an accuracy of the apparatus due to the change of the voltage. However, when a continuous long time of sharp change of the voltage of the system is compensated, the energy storage system having a large capacity is required. Particularly, when the voltage of the system drops, the compensation time and the performance mainly depend on whether the stored energy amount in the RERS may be effectively controlled and applied in real time or not to achieve an effect of overall compensation. The present invention also provides a concept of a multi-compensation energy storage system, in which two or more different RERSs are utilized, and DC energy storage parts in the RERSs are connected and controlled, so as to dispatch and compensate the energy. Therefore, the present invention also provides an improved genetic algorithm as a method for dispatching the renewable energy storage systems, so as to dispatch the energy of different RERSs and continuously control the load for a long time, thus achieving an optimal economic operation with a high electric power quality of the electric power system.

The electric transmission structure of the common regional renewable energy source usually only utilizes a single energy storage backup power source device, which cannot fully utilize the advantages of the diversity and the mixed application of the electric power dispatching of the microgrid. If the energy storage backup power source device of the region fails, the region cannot obtain the power supply through the renewable energy source. The present invention provides a new concept of a multi-compensation energy storage system, in which the DC powers of the internal energy storage systems of the renewable energy sources in different regions are connected and controlled, and the energy storage backup power source is dispatched, so as to greatly improve the reliability of the power supply of the microgrid.

The establishment of a conventional alternating current (AC) power transmission has problems such as three-phase unbalance and distributed power source synchronization, and the transformer and the inductive load elements often result in unpredictable surges because of activation or switching of the switch. The advantage of the DC power is that the distributed power sources of the DC power do not have to be synchronized, and the voltage pulsation resulting from the load effect may be compensated through the application of the design of the energy storage device, such that the establishment of the DC microgrid will gradually become the future trend. The present invention also provides a new concept of a multi-compensation renewable energy storage system, in which the DC powers (usually provided by battery units combined together) stored in the plurality of sets of renewable energy source in different regions are partially connected and controlled, so as to form a transmission network of the DC power of the energy storage backup power source, which is advantageous in gentle charging/discharging voltage, easy acquisition, and high security. A systematic dispatching method of different electrical energy storage devices according to the present invention is used together to integrate the electric output, so as to obtain an independent or regional microgrid, such that the electric power from the hybrid renewable energy source may be effectively and fully utilized.

The present invention provides a network connection manner of a microgrid energy storage backup power source, and a method for dispatching the same. Energy storage systems of renewable energy sources of different regions are jointed, so as to form a DC power network of a backup power source for dispatching energies of different renewable energy sources, so as to achieve high electric power quality and optimal economic operation of the electric power system. Usually, the energy storage device of the RERS also analyzes voltage signals returned from the batteries, and appropriately performs the charging and the protection according to different situations, so as to supply a stable DC power source, and supply the power to the sensitive load through a stabilizing device, thereby preventing from affecting an accuracy of the apparatus due to the change of the voltage. However, when a continuous long time of sharp change of the voltage of the system is compensated, the energy storage system having a large capacity is required. Particularly when the voltage of the system drops, the compensation time and the performance mainly depend on whether the stored energy amount in the energy storage system may be effectively controlled and applied in time or not to achieve an effect of overall compensation. The present invention also provides a new concept of a multi-compensation energy source energy storage system, in which energy storage parts in the energy storage systems of different power supply regions are connected and controlled, so as to dispatch and compensate the energy. The present invention also provides an improved genetic algorithm as a method for dispatching the DC power of the renewable energy storage systems, thus achieving the object of optimal economic operation with a high electric power quality of the electric power system.

### SUMMARY OF THE INVENTION

The present invention is directed to a network connection manner of a microgrid energy storage backup power source, and a method for dispatching the same, in which a plurality of renewable energy storage systems of microgrids are jointed, and an improved genetic algorithm is used as a method for dispatching energies of the plurality of renewable energy storage systems, for enhancing electric power dispatching efficiency of different microgrids, so as to achieve high quality power supply and optimal economic operation of an electric power system.

### BRIEF DESCRIPTION OF THE DRAWINGS

The present invention will become more fully understood from the detailed description given herein below for illustration only, and thus are not limitative of the present invention, and wherein:

FIG. 1 is a schematic view of a plurality of regional renewable energy storage systems being butt-jointed to one another according to the present invention;

FIG. 2 is a schematic view of a plurality of regional renewable energy storage systems being connected through a hub according to the present invention; and

FIG. 3 is a schematic flow chart of a method for dispatching network connection of a microgrid energy storage backup power source according to the present invention.

### DETAILED DESCRIPTION OF THE INVENTION

A more comprehensible description of the present invention is given below with reference to the accompanying drawings, the reference numerals, and the detailed description of the present invention, for assisting the examination works of the examiners.

The present invention provides a network connection manner of a microgrid energy storage backup power source, and a method for dispatching the same, which are a connection manner of multi-compensation energy storage, and a method for dispatching the same. Several sets of internal energy storage systems of renewable energy sources are connected, controlled, and dispatched, in which manners of connecting the internal energy storage systems of renewable energy sources are divided into two types.

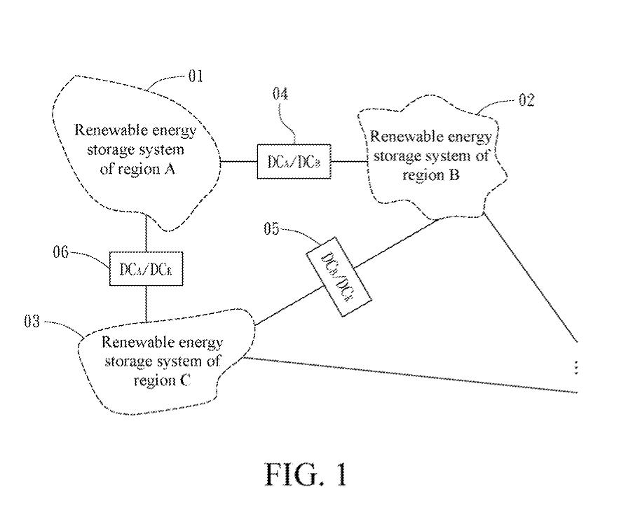

In the first connection type, the regional renewable energy storage systems are butt-jointed. FIG. 1 is a schematic view of the plurality of regional renewable energy storage systems being butt-jointed to one another. Referring to FIG. 1, it is known that a renewable energy storage system 01 of region A, a renewable energy storage system 02 of region B, and a renewable energy storage system 03 of region K are butt-jointed one another, the renewable energy storage system 01 of region A and the renewable energy storage system 02 of region B are connected through DC_{A}/DC_{B} 04, the renewable energy storage system 02 of region B and the renewable energy storage system 03 of region K are connected through DC_{B}/DC_{K} 05, and the renewable energy storage system 01 of region A and the renewable energy storage system 03 of region K are connected through DC_{A}/DC_{K} 06. The butt-joint connection method has a simple structure, but a high cost for future expansion. If the energy storage systems of different regions have different voltage levels, each time when a renewable energy source region is added, K sets of DC/DC converters are required when the added renewable energy source region is connected to other K sets of renewable energy source regions, such that when the microgrid is planned to be established, the energy storage systems of different regions should have consistent voltage levels, for facilitating the expansion of the energy storage systems of the future regions.

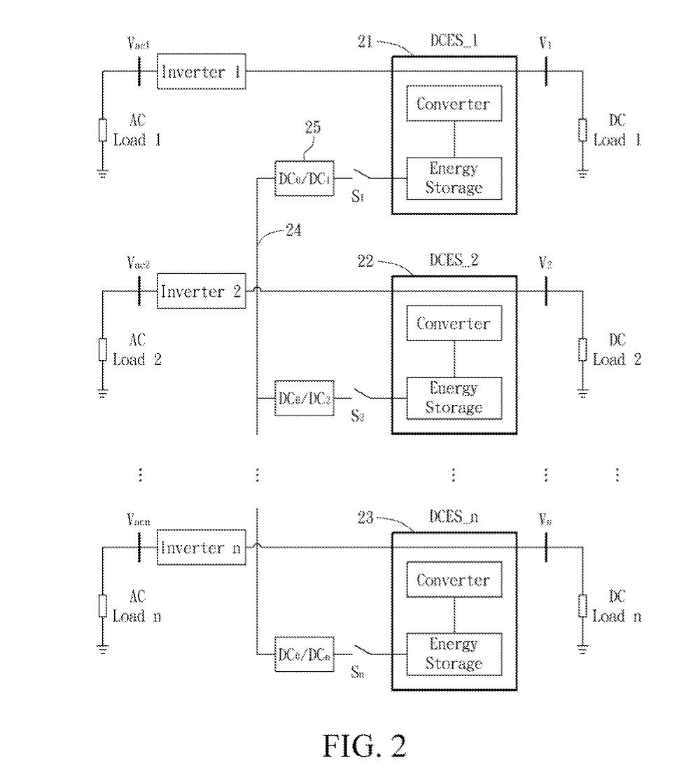

In the second connection type, the renewable energy storage systems are connected in a hub management manner. FIG. 2 is a schematic view of the plurality of regional renewable energy storage systems being connected in the hub management manner according to the present invention. Referring to FIG. 2, it is known that a regional renewable energy storage system 21, a regional renewable energy storage system 22, and a regional renewable energy storage system 23 are connected through a hub 24. The method for connecting the energy storage systems through the hub has a complicated connection structure, but a high expandability in the future. As shown in FIG. 2, DC0 is a hub management voltage of the energy storage system, if a renewable energy source region is added, even the energy storage system of the new renewable energy source region has a different voltage level, only one set of DC₀/DC₁ converter 25 is required, such that it is easily managed and dispatched. However, if the voltage levels of the internal energy storage systems are already unified when an RERS is established, here, the butt-jointing method of the renewable energy source regions has a relatively improved reliability on dispatching path although the connection cost thereof is high.

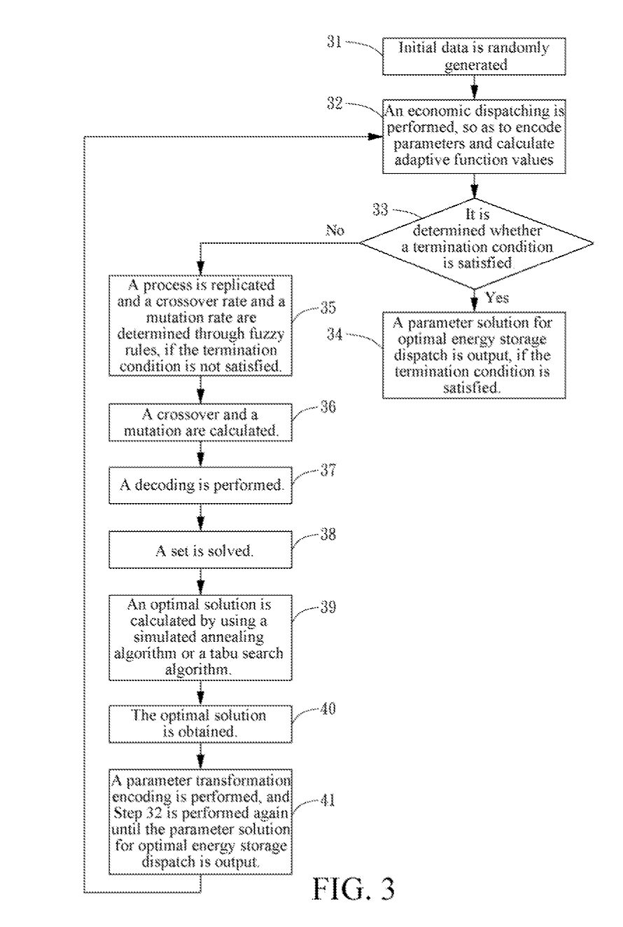

The present invention provides a method for dispatching network connection of a microgrid energy storage backup power source, which serves as a scheduling control method for long-time multi-compensation energy storage systems. FIG. 3 is a schematic flow chart of the method for dispatching network connection of the microgrid energy storage backup power source according to the present invention. Referring to FIG. 3, the main objective of the method is achieving the lowest total operation cost of the system when necessary limit conditions of all apparatus are satisfied. As shown in FIG. 3, the method at least includes the following steps.

In Step 31, initial data is randomly generated.

In Step 32, an economic dispatching is performed, so as to encode parameters and calculate adaptive function values.

In Step 33, it is determined whether a termination condition is satisfied.

In Step 34, if the termination condition is satisfied, a parameter solution for optimal energy storage dispatch is output.

In Step 35, if the termination condition is not satisfied, a process is replicated and a crossover rate and a mutation rate are determined through fuzzy rules.

In Step 36, a crossover and a mutation are calculated.

In Step 37, decoding is performed.

In Step 36, the crossover and the mutation are calculated.

In Step 37, the decoding is performed.

In Step 38, a set is solved.

In Step 39, an optimal solution is calculated by using a simulated annealing algorithm or a tabu search algorithm.

In Step 40, the optimal solution is obtained.

In Step 41, a parameter transformation encoding is performed, and Step 32 is performed again until the optimal parameter solution for energy storage dispatch is output.

To sum up, the structural features and the embodiments of the present invention are disclosed in detail, which fully show that the present invention have implementation novelty and inventive step in terms of objectives and efficacies, and have industrial application. Moreover, the present invention have never been seen in the market, and thus the present invention thoroughly conforms to the requirements for an invention patent according to the law. Though the present invention has been disclosed above by the embodiments, they are not intended to limit the present invention. Equivalent variations and modifications made based on the claims of the present invention shall all fall within the protection scope of the present invention. It will be much appreciated if the application is examined and granted a patent.

What is claimed is:

1. A method for dispatching network connection of a microgrid energy storage backup power source, at least comprising:
(a): randomly generating initial data;
(b): economic dispatching, so as to encode parameters and calculate adaptive function values;
(c): determining whether a termination condition is satisfied;
(d): outputting a parameter solution for optimal energy storage dispatch, if the termination condition is satisfied;
(e): replicating a process and determining a crossover rate and a mutation rate through fuzzy rules, if the termination condition is not satisfied;
(f): calculating the crossover and the mutation;
(g): decoding;
(h): calculating the crossover and the mutation;
(i): decoding;
(j): set solving;
(k): calculating an optimal solution by using a simulated annealing algorithm or a tabu search algorithm;
(l): obtaining the optimal solution; and
(m): parameter transformation encoding, and performing Step (b) again until a parameter solution for optimal energy storage dispatch is output.

2. A network connection device of a microgrid energy storage backup power source, at least comprising:
a plurality of regional renewable energy storage systems, butt-jointed one another through a plurality of DC/DC converters, for dispatching energies among energy storage apparatuses, wherein the plurality of regional renewable energy storage systems uses an energy storage dispatching method to dispatch electric energies stored by different regional renewable energy storage systems, and the energy storage dispatching method at least comprises:
(a1): randomly generating initial data;
(b1): economic dispatching, so as to encode parameters and calculate adaptive function values;
(e1): determining whether a termination condition is satisfied;
(d1): outputting a parameter solution for optimal energy storage dispatch, if the termination condition is satisfied;
(e1): replicating a process and determining a crossover rate and a mutation rate through fuzzy rules, if the termination condition is not satisfied;
(f1): calculating the crossover and the mutation;
(g1): decoding;
(h1): calculating the crossover and the mutation;
(i1): decoding;
(j1): set solving;
(k1): calculating an optimal solution by using a simulated annealing algorithm or a tabu search algorithm;
(l1): obtaining the optimal solution; and
(m1): parameter transformation encoding, and performing Step (b1) again until a parameter solution for optimal energy storage dispatch is output.

3. A network connection device of a microgrid energy storage backup power source, at least comprising:
a plurality of regional renewable energy storage systems, converted to hub management voltage and serially connected through a plurality of DC/DC converters, so as to dispatch energies among energy storage apparatuses, wherein the plurality of regional renewable energy storage systems uses an energy storage dispatching method to dispatch electric energies stored by different regional renewable energy storage systems, and the energy storage dispatching method at least comprises:
(a2): randomly generating initial data;
(b2): economic dispatching, so as to encode parameters and calculate adaptive function values;
(c2): determining whether a termination condition is satisfied;
(d2): outputting a parameter solution for optimal energy storage dispatch, if the termination condition is satisfied;
(e2): replicating a process and determining a crossover rate and a mutation rate through fuzzy rules, if the termination condition is not satisfied;
(f2): calculating the crossover and the mutation;
(g2): decoding;
(h2): calculating the crossover and the mutation;
(i2): decoding;
(j2): set solving;
(k2): calculating an optimal solution by using a simulated annealing algorithm or a tabu search algorithm;
(l2): obtaining the optimal solution; and
(m2): parameter transformation encoding, and performing Step (b2) again until a parameter solution for optimal energy storage dispatch is output.
